(19) United States
(12) Patent Application Publication
(10) Pub. No.: US 2019/0358715 A1
(43) Pub. Date: Nov. 28, 2019

(54) HOLE-DRILLING GUIDING DEVICE

(71) Applicant: Ben Yu, Taichung City (TW)

(72) Inventor: Ben Yu, Taichung City (TW)

(21) Appl. No.: 15/989,192

(22) Filed: May 25, 2018

(51) Int. Cl. B23B 51/00

(52) U.S. Cl. CPC B23B 51/0054; B23B 47/26

(57) ABSTRACT

A hole-drilling guiding device includes a base including a bottom seat and two vertical seats extending upward from the bottom seat. The bottom seat has a bottom surface including two coupling bar fixation sections. Two rotary seats are respectively and rotatably coupled to the vertical seats. A rotary knob is coupled to one of the rotary seats. A handle is coupled to the other one of the rotary seats. Two guide posts are received through the rotary seats. A chuck seat is fit to the guide posts. A chuck is rotatably mounted to the chuck seat. Two coupling bars are provided, each including a bar body, a rotation driving section at one end of the bar body, and a first fixation section at an opposite end of the bar body. The first fixation sections of the coupling bars are selectively and removably coupled to the coupling bar fixation sections of.

### (a) TECHNICAL FIELD OF THE INVENTION

The present invention relates generally to an assistive device for hole drilling, and more particularly to a hole-drilling guiding device.

### (b) DESCRIPTION OF THE PRIOR ART

As shown in FIG. 1, a conventional hole-drilling guiding device 90 generally comprises a bottom seat 91, two vertical walls 92, two sleeves 93, a rotary knob 94, a handle 95, two guide posts 96, a chuck seat 97, and a chuck 98. The bottom seat 91 is formed with a through hole 911 in a central portion thereof and penetrating through top and bottom thereof and two penetration holes 912 located on two opposite sides of the through hole 911. The two vertical walls 92 extends upward in a vertical direction from two opposite side portions of the bottom seat 91. Each of the vertical walls 92 comprises an arc slot 921 extending inside and outside surfaces thereof. Each of the vertical walls 92 is provided, on the outside surface thereof, with an angle indicator zone 922 that is located above the arc slot 921. The two sleeves 93 are arranged at locations that are above the penetration holes 912 of the bottom seat 91. Each of the sleeves 93 is formed with a sliding hole 931 penetrating through top and bottom ends thereof. Each of the sleeves 93 is formed with a pivotal projection (not shown) on and projecting from an outer side thereof. The pivotal projections are received in the arc slots 921. The rotary knob 94 is arranged on the outside surface of one of the vertical walls 92 and is coupled to the pivotal projection of one of the sleeves 93. The handle 95 is arranged on the outside surface of the other one of the vertical walls and is coupled to the pivotal projection of the other one of the sleeves 93. The two guide posts 96 are respectively received through the sliding holes 931 of the sleeves 93. The chuck seat 97 is rotatably mounted between the two guide posts 96 and is movable upward and/or downward, through sliding, along the guide posts 96. The chuck 98 is rotatably mounted to the chuck seat and is operable as being acted by an external force to rotate on-site.

As such, to use the hole-drilling guiding device 90, the two guide posts 96 are first extended out of the penetration holes 912 of the bottom seat 91 to project under the bottom seat so that the portions of the two guide posts 96 that project under the bottom seat 91 may be positionable against two sides of a workpiece 991. The chuck 98 is then operated to clamp a cutting tool 992, and a driving tool 993 drives the chuck 98 and the cutting tool 992 to rotate in order to carry out a hole drilling operation on the workpiece 991.

However, when the guide posts 96 are set in and extend through the penetration holes 912 of the bottom seat 91, no means is provided for retention between the guide posts 96 and the bottom seat 91 so that it is not possible to adjust a relative angular position between the guide posts 96 and the cutting tool 992, making it inconvenient in use.

### SUMMARY OF THE INVENTION

In view of the above, the present invention is made to overcome the problem of the known hole-drilling guiding device that it is not possible to adjust the angular position.

The primary objective of the present invention is to provide a hole-drilling guiding device, which allows for easy and timely adjustment of an angular position of a cutting tool.

Another objective of the present invention is to provide a hole-drilling guiding device, which allows for positioning at a specific angle.

A further objective of the present invention is to provide a hole-drilling guiding device, which is combinable with a clamping device that fixes a workpiece.

The present invention provides a hole-drilling guiding device, which generally comprises: a base, which comprises a bottom seat and two vertical seats respectively extending upward from two opposite side portions of the bottom seat, the bottom seat having a central portion that is formed with a through hole extending through a top surface and a bottom surface thereof, the bottom surface of the bottom seat comprising a plurality of coupling bar fixation sections formed therein, each of the vertical seats comprising an arc slot extending through an inside surface and an outside thereof and an angle indicator zone formed on the outside surface of the vertical seat and located above the arc slot; two rotary seats, each of which comprises a sliding hole extending through a top and a bottom thereof, each of the rotary seats comprising a rotary bar formed on an outer side thereof, each of the rotary seats being arranged such that the rotary bar is received, from inside to outside, into the arc slot of a respective one of the vertical seats, such that the rotary seat is rotatably coupled the respective one of the vertical seats; a rotary knob, which is coupled, on the outside of a first one of the vertical seats, to the rotary bar of a respective one of the rotary seats; a handle, which is coupled, on the outside of a second one of the vertical seats, to the rotary bar of a respective one of the rotary seats, such that when the rotary knob and the handle are tightened, the rotary seats are securely fixed on the vertical seats and are prevented from rotation, and when the rotary knob and the handle are released, the rotary seats are rotatable, in a reciprocal manner, along the arc slots within a predetermined angular range; two guide posts, which are respectively inserted into the sliding holes of the rotary seats; a chuck seat, which is fit to the two guide posts and is slidable, in a reciprocal manner, along the guide posts; a chuck, which is rotatably mounted to the chuck seat and is adapted to be acted upon by an external force to rotate on-site; a plurality of coupling bars, each of which comprises a bar body, a rotation driving section formed at one end of the bar body, and a first fixation section formed at an opposite end of the bar body, the first fixation section of each of the coupling bars being selectively coupled to a respectively one of the coupling bar fixation sections of the base to project outside the bottom surface of the bottom seat, the coupling bar being selectively removable from the coupling bar fixation section. As such, the rotary seats and the guide posts are arranged in a rotatable manner without being unduly constrained so that an angular position of a cutting tool attached to the chuck may be adjusted.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a known hole-drilling guiding device in an assembled form.

FIG. 2 is an exploded view showing a preferred embodiment of the present invention.

FIG. 3 is an assembled view of the embodiment shown in FIG. 2.

FIG. 4 is a perspective view, as well as partial sectioned view, of the embodiment of FIG. 2 in an assembled form.

FIGS. 5-8 illustrate an operation of the embodiment shown in FIG. 2.

FIGS. 9 and 10 are schematic views illustrating another example of the embodiment of the FIG. 2.

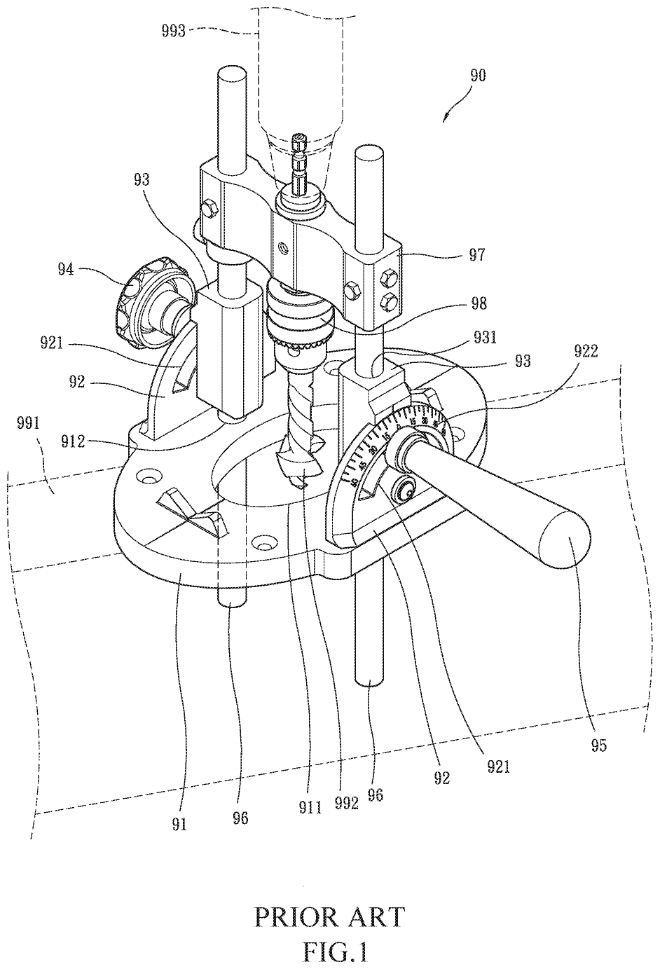

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

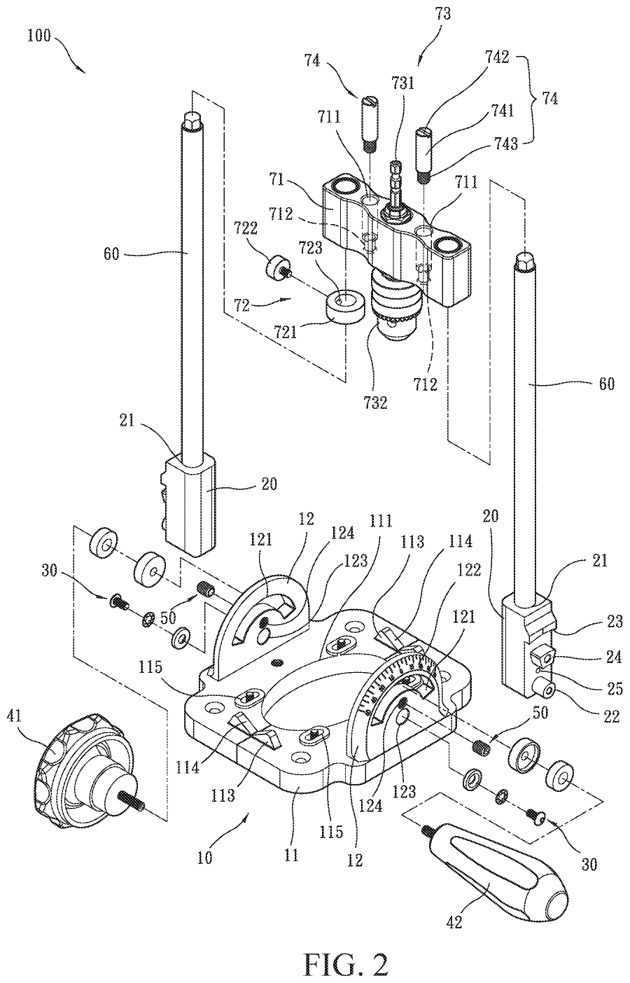

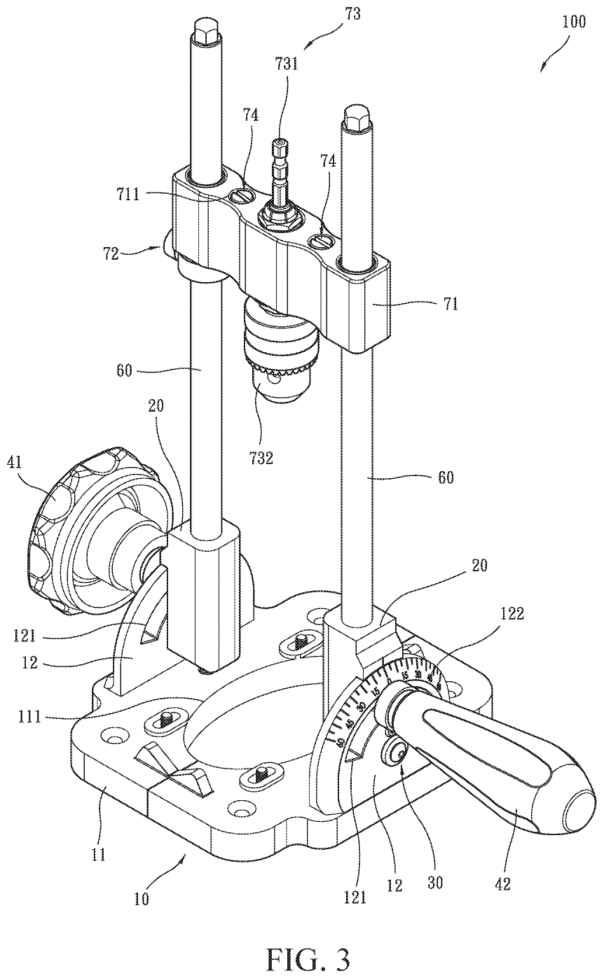

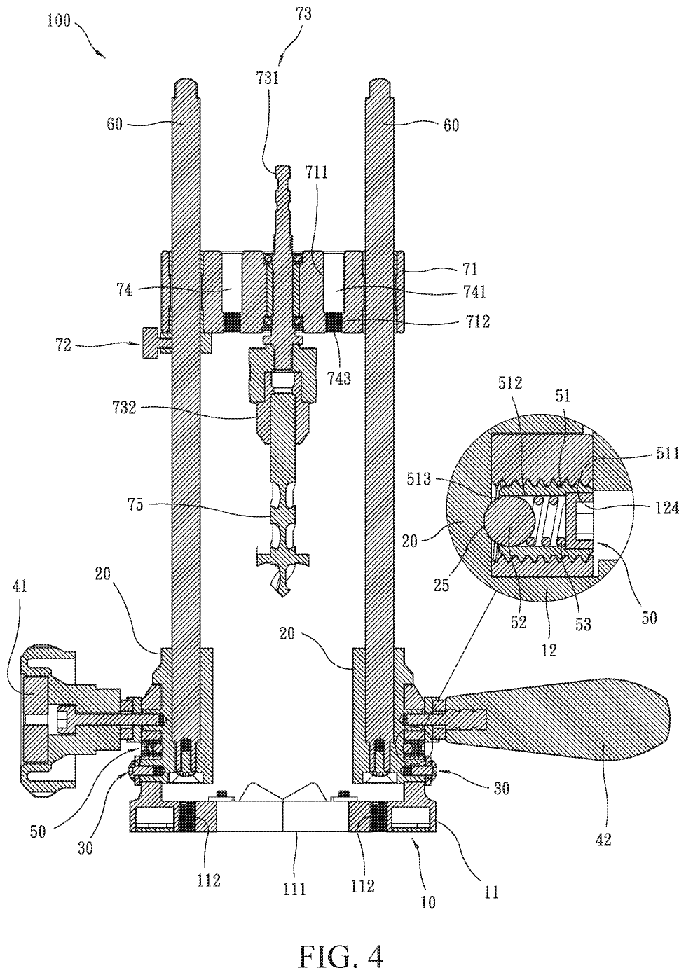

Referring to FIGS. 2-10, the present invention provides, in a preferred embodiment, a hole-drilling guiding device 100, which generally comprises a base 10, two rotary seats 20, two pivotal connection units 30, a rotary knob 41, a handle 42, two positioning members 50, two guide posts 60, a chuck seat 71, a position limiter 72, a chuck 73, and two coupling bars 74.

Referring to FIGS. 2-4, the base 10 comprises a bottom seat 11 and two vertical seats 12. The bottom seat 11 is formed, in a central portion thereof, with a through holes 11 that extends through top and bottom sides of the bottom seat. The bottom seat 11 has a bottom surface that comprises two coupling bar fixation sections 112 that are spaced from each other by a predetermined spacing distance. The coupling bar fixation sections 112 each comprise a threaded hole. The two coupling bar fixation sections 112 are located at two opposite sides of the through hole 111, respectively. The two vertical seats 12 are integrally formed with and extend upward from a top surface of the bottom seat 11. The two vertical seats 12 are respectively arranged at two opposite sides of the through hole 11. Each of the vertical seats 12 has a top edge that has an arc or curved configuration. Each of the vertical seats 12 comprises an arc slot 121 that extend through inside and outside surfaces thereof and an angle indicator zone 122 that is arranged on the outside surface of the vertical seat 12 and located above the arc slot 121; and also, the vertical seat 12 is formed with a pivot hole 123 that extends through inside and outside surfaces thereof and is located below the arc slot 121 and a threaded positioning hole 124 that is located between the arc slot 121 and the pivot hole 123 and extends through the inside and outside surfaces of the vertical seats 12.

Referring to FIGS. 2-4, each of the rotary seats 20 comprises a sliding hole 21 extending through top and bottom thereof. The rotary seats 20 are each provided, on an outer side thereof, with a rotary connection bar 22, an arc supporting wall 23 located above the rotary connection bar 22, a rotary bar 24 located between the rotary connection bar 22 and the arc supporting wall 23, and a positioning slot 25 located between the rotary connection bar 22 and the rotary bar 24. The two rotary seats 20 are arranged on the base 10. Each of the rotary seats 20 is arranged such that the rotary connection bar 22 is put, from inside to outside, into and extend through the pivot hole 123 of the respective vertical seat 12; the rotary bar 24 is put into and extends through the arc slot 121 of the respective vertical seat 12; and the are supporting wall 23 is positioned against the top edge of the respective vertical seat 12.

Referring to FIGS. 2-4, the two pivotal connection units 30 are arranged to insert, from the outside of the respective vertical seats 12, into and through the pivot holes 123 and coupled to the rotary connection bars 22 of the respective rotary seats 20 such that the rotary seats 20 are allow for reciprocal rotation within a predetermined range of angle.

Referring to FIGS. 2-4, the rotary knob 41 is coupled, from the outside of one of the vertical seats 12, to the rotary bar 24 of one of the rotary seats 20 so that when the rotary knob 41 is rotated and tightened, the rotary seat 20 is securely fixed to the one of the vertical seats 12 and is prevented from further rotation. When the rotary knob 41 is released, the rotary seat 20 is allowed to reciprocally rotate about a center defined by the rotary connection bar 22 for movement along the arc slot 121 within a predetermined range of angle.

Referring to FIGS. 2-4, the handle 42 is coupled, from the outside of the other one of the vertical seats 12, to the rotary bar 24 of the other rotary seats to be grip and held by a user's hand. When the handle 42 is rotated and tightened, the rotary seat 20 is securely fixed to the other one of the vertical seats 12 and is prevented from further rotation. When the handle 42 is released, the rotary seat 20 is allowed to reciprocally rotate about a center defined by the rotary connection bar 22 for movement along the arc slot 121 within a predetermined range of angle.

Referring to FIGS. 2-4, the positioning members 50 each comprise a threaded rod 51, a sphere 52, and a spring 53. The threaded rod 51 has an outside surface that comprises an external thread 511 formed thereon. The threaded rod 51 is formed, in an interior thereof, with a receiving channel 512 and an opening 513 that connects the receiving channel 512 to the outside. The receiving channel 512 has a diameter that is greater than a diameter of the sphere 52 and the opening 513 has a diameter that is smaller than the diameter of the sphere 52. The sphere 52 is arranged in the receiving channel 512 of the threaded rod 51. The spring 53 is supported between and in abutting engagement with the sphere 52 and the receiving channel 512 so that the spring 53 provides a spring force that biases the sphere 52 in a direction toward the opening 513. Each of the positioning members 50 is screwed, through the external thread 511 thereof, in the threaded positioning hole 124 of the respective vertical seat 12 with the sphere 52 facing the inside of the vertical seat 12.

Referring to FIGS. 2-4, the two guide posts 60 are respectively inserted into and extend through the sliding holes 21 of the rotary seats 20.

Referring to FIGS. 2-4, the chuck seat 71 is fit to the two guide posts 60 to be slidable upward and/or downward along the guide posts 60. The chuck seat 71 has a top surface that is formed with two receptacle compartments 711. Each of the two receptacle compartment 711 has a bottom that comprises a second fixation section 712. The second fixation section 712 may comprise a threaded hole.

Referring to FIGS. 2-4, the position limiter 72 is arranged on one of the guide posts 60 and is reciprocally slidable along and positionable on the guide post 60 to limit position of the chuck seat 71 to which the chuck seat is moved, through sliding. The position limiter 72 comprises a ring 721 and a bolt 722. The ring 721 is fit over the one of the guide posts 60. The ring 721 comprises a threaded hole 723. The bolt 722 is received in and in threading engagement with the threaded hole 723 so that the bolt 722, when rotated and tightened, is set against, through abutting engagement, the guide post 60 to constrain the position of the chuck seat 71. When the bolt 722 is rotated and released, the ring 721 is allowed to slide along the guide post 60 to allow for adjustment of the position of the chuck seat 71.

Referring to FIGS. 2-4, the chuck 73 is rotatably mounted to the chuck seat 71 and may be, as being acted upon by an external force, rotatable on-site with respect to the chuck seat 71. The chuck 73 comprises a driving section 731 extending outside the top surface of the chuck seat 71 and a clamping section 732 extending outside a bottom surface of the chuck seat 71.

Referring to FIGS. 2-4, each of the coupling bars 74 comprises a bar body 741, a rotation driving section 742 formed at one end of the bar body 741, and a first fixation section 743 formed at an opposite end of the bar body 741. The first fixation section 743 may comprise an external thread. The rotation driving section 742 is connectable with an external tool for being driven thereby to rotate. In the embodiment, the rotation driving section 742 comprises a linear slot. Each of the coupling bars 74 is received in the respective receptacle compartment 711 of the chuck seat 71 and the first fixation section 743 is screwed to the second fixation section 712 so that each of the coupling bars 74 can be kept in the respective receptacle compartment 711.

The above provides an introduction to the components of the hole-drilling guiding device 100 according to one preferred embodiment of the present invention and the assembly thereof. Features of use will be described below.

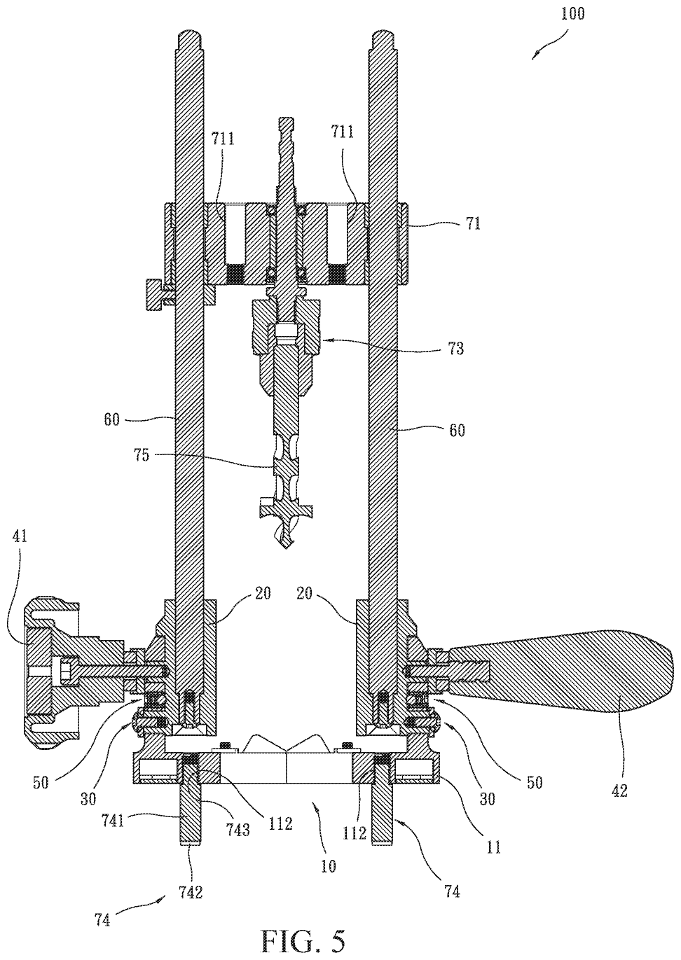

To use the present invention, as shown in FIG. 5, the clamping section 732 of the chuck 73 is first operated to clamp and hold a cutting tool 75. The two coupling bars 74 are removed from the receptacle compartments 711 and the two coupling bars 74 are set such that the first fixation sections 743 thereof are screwed into the coupling bar fixation sections 112 of the base 10 with the bar body 741 of each of the coupling bars 74 projects outside the bottom of the base 10.

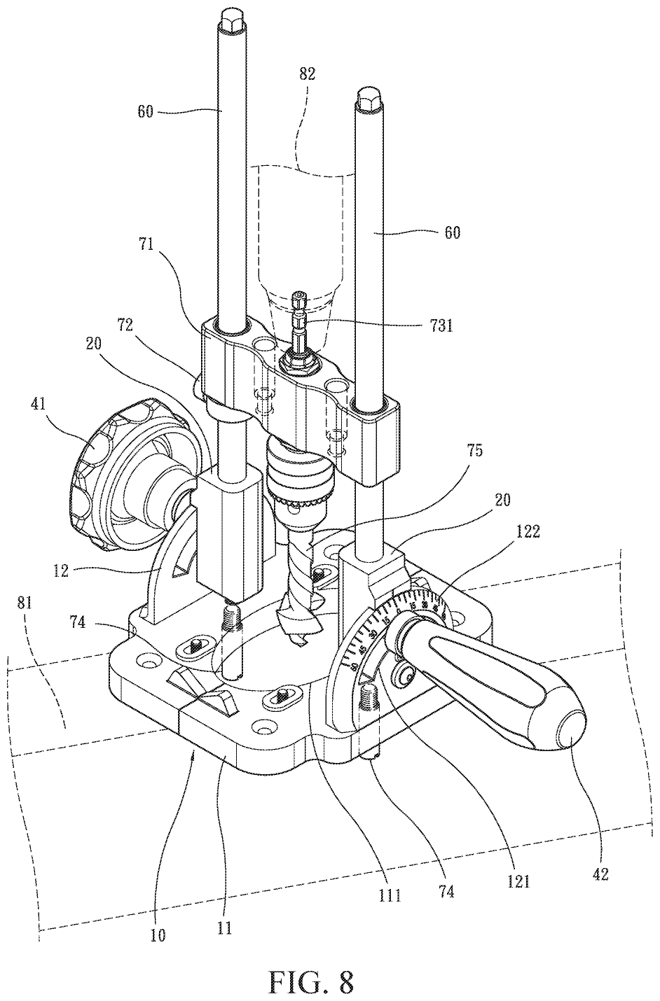

In this way, as shown in FIG. 8, the bottom of the base 10 can be positioned against a workpiece 81 and, if necessary, the present invention is rotated to set the two coupling bars 74 against two sides of the workpiece 71, respectively, in order to fix the position of the present invention with respect to the workpiece 81. Afterwards, a driving tool 82 is set to couple to the driving section 731 of the chuck 73 and applies a torque to the chuck 73 to cause the cutting tool 75 to rotate synchronously for carrying out a hole drilling operation on the workpiece 81. When the two coupling bars 74 are not used, the two coupling bars 74 may be received, fixed, and stored in the two receptacle compartments 711 of the chuck seat 71.

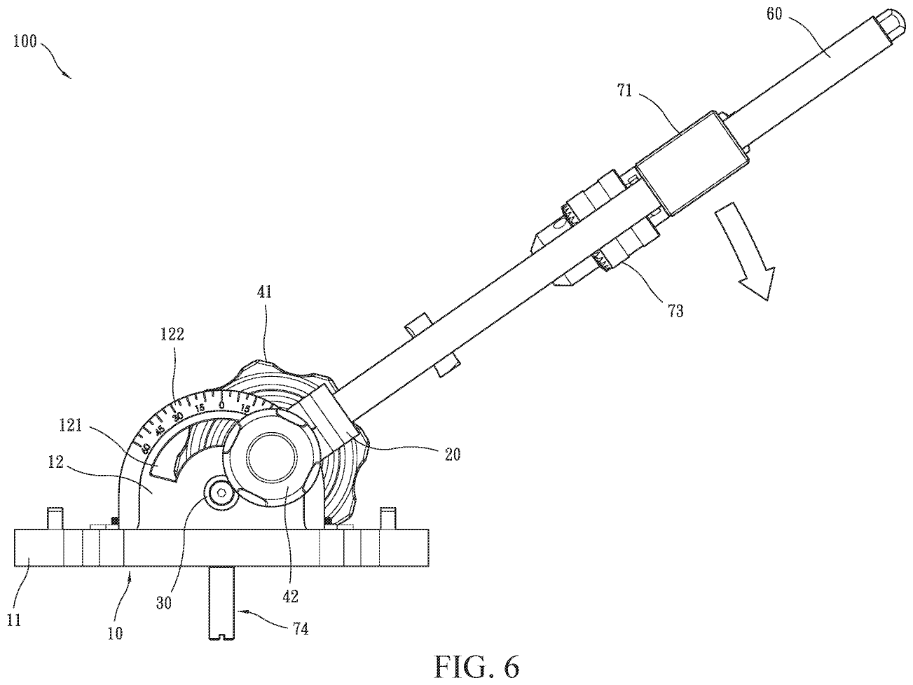

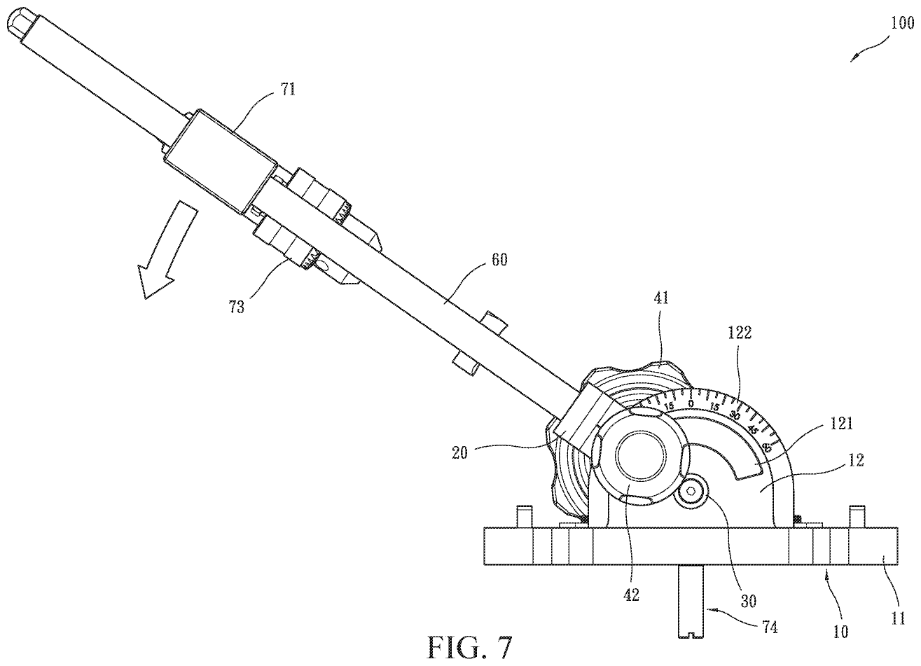

In the present invention, the guide posts 60 do not extend through the base 10, and the coupling bars 74 are used instead to coupled to the bottom of the base 10 for being positioned against the workpiece. For all circumferences, it only needs to release the rotary knob 41 and the handle 42 to allow the two guide posts 60 and two rotary seats 20 to do rotation, in a reciprocal manner, within a predetermined angular range so as to achieve an effect of adjusting an angular position of the cutting tool 732 at any time (as shown in FIGS. 6 and 7) thereby improving the convenience of use.

Further, the two vertical seats 12 of the base 10 are provided, respectively, with the threaded positioning holes 124 to receive the positioning members 50 to screw thereto, such that when the rotary seats 20 are in a vertical condition as having an angle of 90 degrees with respect to the bottom seat 11 (where the angle indicator zone 122 indicates 0 degree), the sphere 52 of each of the positioning members 50 is partially fit into the positioning slot 25 of the respective rotary seat 20 to provide an effect of fixing the bottom seat 12 and the rotary seats 20 with respect to each other thereby helping reduce an angular error occurring in hole drilling.

Further, as shown in FIG. 2, the top of the bottom seat 11 of the base 10 is provided with two support blocks 113 raised up therefrom at locations frontward and rearward of the through hole 111, respectively. Each of the support blocks 113 has a top that comprises a V-shaped notch 114 formed therein to receive and hold a circular workpiece therein for preventing rotation of the workpiece. A reference line 116 is provided on the top of the bottom seat 11 at a location corresponding to a bottom of the V-shaped notch 114 and extends outward to a side surface of the bottom seat 11 to allow for calibration desired and carried out by a user.

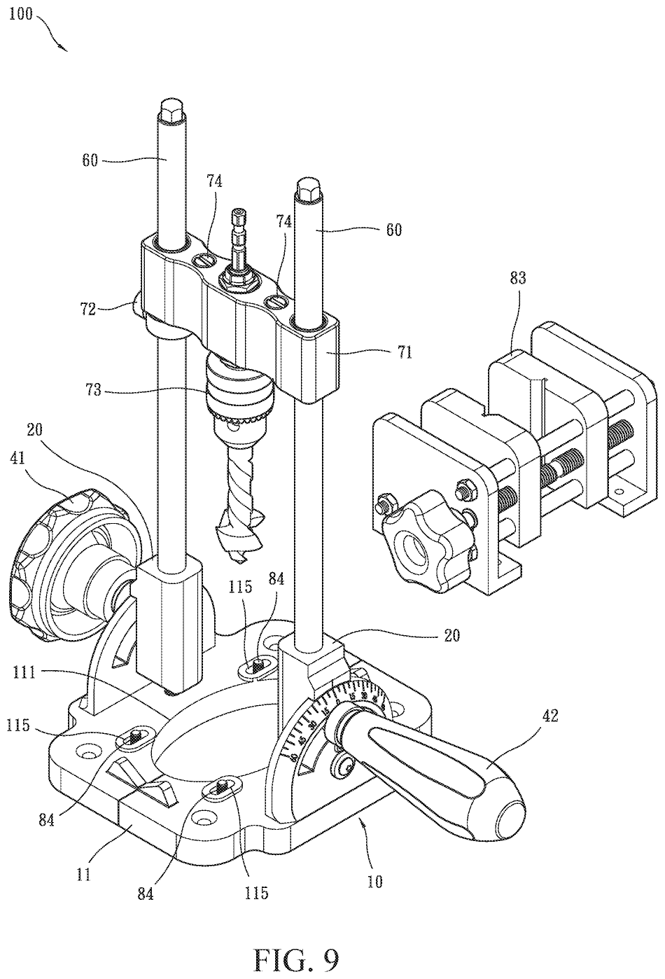

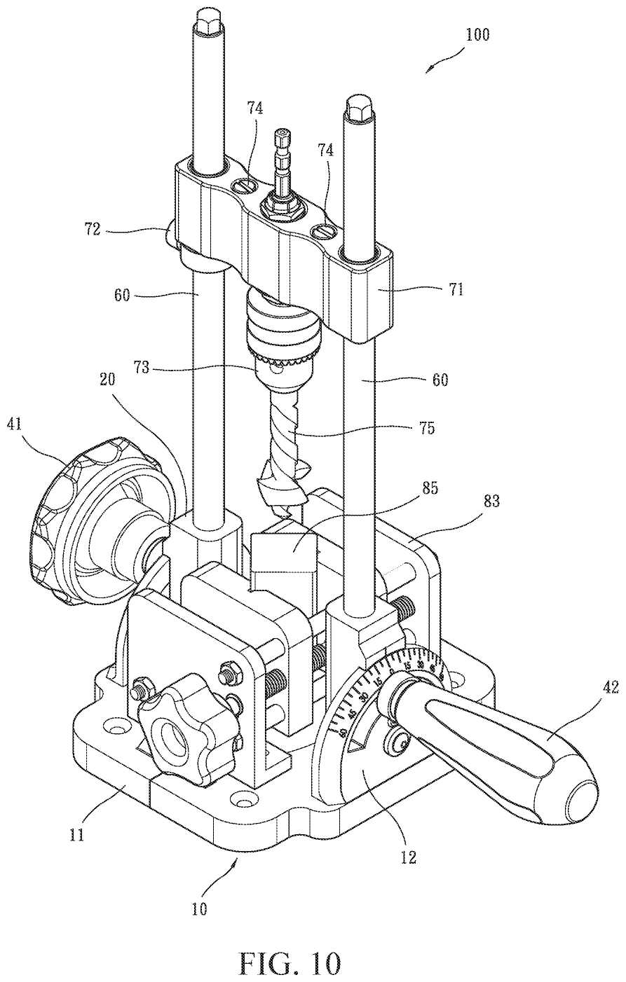

Further, as shown in FIGS. 9 and 10, the bottom seat 11 of the base 10 is formed with a plurality of locking holes 115 that extend through the top and bottom thereof at locations around the through hole 111 to receive a clamping device 83 (such as vise) positioned on the bottom seat 11 with a plurality of bolts 84 received in and extending through the locking holes 115 to engage and fix the clamping device 83 in position. The clamping device 83 may clamp and hold a workpiece 85 to allow hole drilling to be carried out on the workpiece 85 fixed in the clamping device 83.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1: A hole-drilling guiding device, comprising:
a base, which comprises a bottom seat and two vertical seats respectively extending upward from two opposite side portions of the bottom seat, the bottom seat having a central portion that is formed with a through hole extending through a top surface and a bottom surface thereof, the bottom surface of the bottom seat comprising a plurality of coupling bar fixation sections formed therein, each of the vertical seats comprising an are slot extending through an inside surface and an outside thereof and an angle indicator zone formed on the outside surface of the vertical seat and located above the arc slot;
two rotary seats, each of which comprises a retention hole extending through a top and a bottom thereof, each of the rotary seats comprising a rotary bar formed on an outer side thereof, each of the rotary seats being arranged such that the rotary bar is received, from inside to outside, into the arc slot of one of the vertical seats corresponding to the rotary seat, and the rotary seat is rotatably coupled the one of the vertical seats corresponding to the rotary seat;
a rotary knob, which is coupled, on the outside of a first one of the vertical seats, to the rotary bar of one of the rotary seats corresponding to the first one of the vertical seats;
a handle, which is coupled, on the outside of a second one of the vertical seats, to the rotary bar of one of the rotary seats corresponding to the second one of the vertical seats, such that when the rotary knob and the handle are tightened, the rotary seats are securely fixed on the vertical seats and are prevented from rotation, and when the rotary knob and the handle are released, the rotary seats are rotatable, in a reciprocal manner, along the arc slots within a predetermined angular range;
two guide posts, which are respectively inserted into the retention holes of the rotary seats;
a chuck seat, which is fit to the two guide posts and is slidable, in a reciprocal manner, along the guide posts;
a chuck, which is rotatably mounted to the chuck seat and is adapted to be acted upon by an external force to rotate on-site;
a plurality of coupling bars, each of which comprises a bar body, a rotation driving section formed at one end of the bar body, and a first fixation section formed at an opposite end of the bar body, the first fixation section of each of the plurality of coupling bars being selectively coupled to one of the plurality of coupling bar fixation sections of the base to project outside the bottom surface of the bottom seat, the plurality of coupling bars being selectively removable from the coupling bar fixation sections;
wherein the chuck seat is formed with a plurality of receptacle compartments that extend to a top surface of the chuck seat, the receptacle compartments having a bottom forming a second fixation section, the plurality of coupling bars being selectively received in the plurality of receptable compartments and retained in the plurality of receptable compartments through coupling between the second fixation sections of the plurality of receptable compartments and the first fixation sections of the plurality of coupling bars.

2. (canceled)

3: The hole-drilling guiding device according to claim 1 further comprising two pivotal connection units, wherein each of the vertical seats is formed with a pivot hole located below the arc slot and extending through the inside surface and the outside surface thereof; and each of the rotary seats has an outside surface that is provided with a rotary connection bar, which is received in the pivot hole of the respective one of the vertical seats such that the pivotal connection units are respectively coupled to the rotary connection bars to provide rotatable connection between the rotary seats and the vertical seats.

4: The hole-drilling guiding device according to claim 1 further comprising two positioning members, wherein each of the vertical seats comprises a threaded positioning hole extending through the inside surface and the outside surface thereof; each of the rotary seats is provided, on the outer side thereof, with at least one positioning depression; the positioning members are respectively screwed to the threaded positioning holes of the vertical seats so that when the rotary seats are set at a predetermined location, the positioning members are set to correspond, in position, to the positioning depressions, wherein the positioning members each comprise a threaded rod, a sphere, and a spring, the threaded rod having an outside surface that comprises an external thread formed thereon, the external thread being screwable into the threaded positioning hole, the threaded rod formed, in an interior thereof, with a receiving channel and an opening communicating between the receiving channel and outside of the threaded rod, the receiving channel having a diameter that is greater than a diameter of the sphere, the opening having an opening that is smaller than the diameter of the sphere, the sphere being received in the receiving channel of the threaded rod, the spring being supported between the sphere and the receiving channel, the spring providing a spring force that biases the sphere in a direction toward the opening, such that when the positioning member corresponds, in position, to the positioning depression, the sphere is biased to partly fit into the positioning depression.

5: The hole-drilling guiding device according to claim 1 further comprising a position limiter arranged on one of the guide posts to be slidable along the guide post for selectively positioning thereon to constrain a position of the chuck seat, wherein the position limiter comprises a ring and a bolt, the ring being fit over the guide post, the ring comprising a threaded hole, the bolt being screwed in the threaded hole such that the bolt, when tightened, is in abutting engagement with the guide post to constrain the position of the chuck seat, and when the bolt is released, the ring is allowed to slide along the guide post for adjustment of the position of the chuck seat.

6: The hole-drilling guiding device according to claim 1, wherein the chuck comprises a driving section projecting outside a top surface of the chuck seat and a clamping section projecting outside a bottom surface of the chuck seat.

7: The hole-drilling guiding device according to claim 1, wherein the coupling bar fixation sections each comprise a threaded hole, and the first fixation sections of the coupling bars each comprise an external thread.

8: The hole-drilling guiding device according to claim 1, wherein the bottom seat is formed with a plurality of locking holes extending through the top surface and the bottom surface thereof and adapted to fix a clamping device on the bottom seat.

9: The hole-drilling guiding device according to claim 1, wherein the top surface of the bottom seat of the base is provided with two support blocks raised up therefrom and respectively in front of and behind the through hole, each of the support blocks having a top that comprises a V-shaped notch formed therein, a reference being provided on the top surface of the bottom seat at a location corresponding to a bottom of the V-shaped notch and extending to a side surface of the bottom seat.

10: The hole-drilling guiding device according to claim 1, wherein the second fixation sections of the receptacle compartments each comprise a threaded hole.
